(19) United States
(12) Patent Application Publication
(10) Pub. No.: US 2023/0383111 A1
(43) Pub. Date: Nov. 30, 2023

(54) DRYER ADDITIVE DELIVERY DEVICE WITH TIME RELEASED ACTIVITIES

(71) Applicant: Albert Santelli, JR., Middlesex, NJ (US)

(72) Inventor: Albert Santelli, JR., Middlesex, NJ (US)

(21) Appl. No.: 18/325,477

(22) Filed: May 30, 2023

Related U.S. Application Data
(60) Provisional application No. 63/346,585, filed on May 27, 2022.

(51) Int. Cl. C08L 31/04; D06F 58/20

(52) U.S. Cl. CPC C08L 31/04; D06F 58/203

(57) ABSTRACT

A dryer additive delivery device including one or more time released actives. The dryer additive delivery device is formed of a thermoplastic material. The active can include a fragrance and hydrogenated tallow. The fragrance can be infused in the thermoplastic material.

### BACKGROUND OF THE INVENTION

### Field of the Invention

The present invention is directed to a device to be used in a dryer for release of active materials and in particular to a dryer additive delivery device providing time release of active materials included in the disk.

### Description of Related Art

Fragrance conventionally has been applied to clothes or fabrics during washing and drying of the clothes or fabrics. In one application, liquid fabric softener having a fragrance is released into a washer during washing of the clothes or fabrics. In another application, fabric softener is available in a dryer sheet. The dryer sheet is placed in the dryer along with wet laundry. The dryer sheet is a nonwoven fabric containing a solid composition that includes the fabric softener and a fragrance. During the drying cycle, the temperature increases as the laundry dries, causing the solid composition to melt and transfer the fabric softener and fragrance from the nonwoven sheet to the laundry. Dryer sheets are generally provided for a single use. The used dryer sheet is not recycled and is discarded as trash.

U.S. Pat. No. 7,871,975 describes a fabric treatment composition which includes a fabric treatment agent and a carrier component for containing the fabric treatment agent in a solid form during operation conditions in a dryer. The fabric treatment composition is constructed for transferring the composition to wet fabric as a result of solubilizing the fabric treatment composition by contacting the fabric treatment composition with the wet fabric during a drying operation in a dryer. A fabric treatment agent comprises a quaternary ammonium component and a silicone component. The composition can be provided in the form of a block for attachment to an interior wall of a dryer, in the form of a ball for free placement within a dryer, and in the form of a pellet, a tablet, or moulded unit. In addition, the composition can be provided as a laminate to a fabric to provide a dryer sheet. A method for treating fabric in described which includes the steps of allowing fabric containing free water to contact the fabric treatment composition inside a dryer during a drying operation and transferring at once the fabric treatment agent from the fabric treatment composition to the fabric as a result of solubilizing the fabric treatment agent with the free water in the fabric.

It is desirable to provide an improved reusable dryer additive delivery device including timed release of actives for providing scent, anti-static and anti-wrinkle properties to clothes and fabrics during drying in a dryer.

### SUMMARY OF THE INVENTION

The present invention relates to a dryer additive delivery device. The dryer additive delivery device being formed of a composition to provide timed release of actives included in the composition. The dryer additive delivery device can be formed from plastic moulded into a desired shape.

The composition for the dryer additive delivery device can comprise wax, a thermoplastic material and a fragrance. In one embodiment, the wax is hydrogenated tallow fatty acid (HTFA). Suitable materials for the thermoplastic material include high density poly ethylene (HDPE) and ethyl vinyl acetate (EVA). The composition can also include stearic acid and sodium stearate. A color additive can be included in the composition.

During use in a dryer, the wax within the thermoplastic material of the dryer additive delivery device can melt during drying to release over time the hydrogenated tallow and the actives contained in the dryer additive delivery device composition. The released stearate actives provide lubricant properties to the fabrics in the dryer to enhance anti-static and anti-wrinkle properties. The fabrics can include clothing. The fabrics are relaxed to control wrinkles.

In one embodiment, the fragrance is infused or trapped in the ethyl vinyl acetate (EVA). The dryer additive delivery device can be formed from a blended polymer compound with the additive. Processing of the blended polymer compound results in the fragrance or other additive being infused or trapped in the polymer. In one embodiment, the additive is a fragrance oil. The blended polymer compound can be combined with a thermoplastic material. The composition can be injection moulded into the shape of the dryer additive delivery device.

The fragrance can be highly concentrated in the dryer additive delivery device. The polymer of the dryer additive delivery device can retain the fragrance for long lasting effect. The dryer additive delivery device can release the fragrance for over 48 hours of drying. The ethyl vinyl acetate (EVA) holds the fragrance and allows release of the fragrance from the dryer additive delivery device over time. The dryer additive delivery device of the present invention can be used to separately release for different actives of tallow, fragrance, stearic acid and sodium stearate

The dryer additive delivery device can have a streamlined shape. For example, the dryer additive delivery device can have an oval or circular shape. The dryer additive delivery device can have a streamline shape to allow the dryer additive delivery device to slide freely throughout fabrics and clothing in a clothes dryer minimizing hang-ups and creating less friction between the dryer additive delivery device and the fabrics and/or clothing.

In one embodiment, one or more of the dryer additive delivery devices can be placed in a clothes dryer before or after loading clothes into the clothes dryer. The one or more dryer additive delivery devices can be used during a drying cycle. During the drying cycle, the dryer additive delivery device releases the actives over time. After the drying cycle, the one or more dryer discharge devices can be removed from the dryer and re-used in subsequent drying cycles. The dryer additive delivery device is formed of recyclable materials can be recycled.

The invention will be more fully described by reference to the following drawings.

### BRIEF DESCRIPTION OF THE DRAWINGS

FIG. 1A is a perspective view of a dryer additive delivery device in accordance with the teachings of the present invention.

FIG. 1B is a front view of the dryer additive delivery device.

FIG. 1C is a side view of the dryer additive delivery device.

FIG. 1D is a rear view of the dryer additive delivery device.

FIG. 2 is a schematic diagram of use of the dryer additive delivery device in a clothes dryer.

Embodiments of the present disclosure and their advantages are best understood by referring to the detailed description that follows. It should be appreciated that the figures may not be necessarily drawn to scale.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

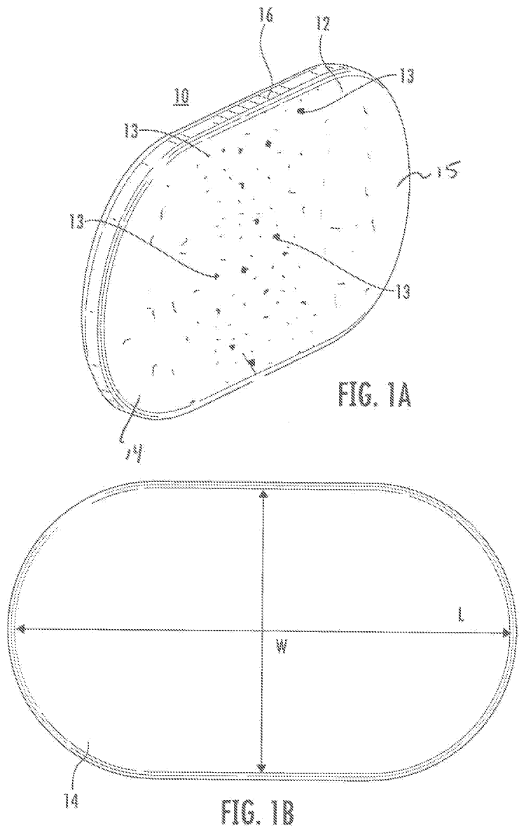

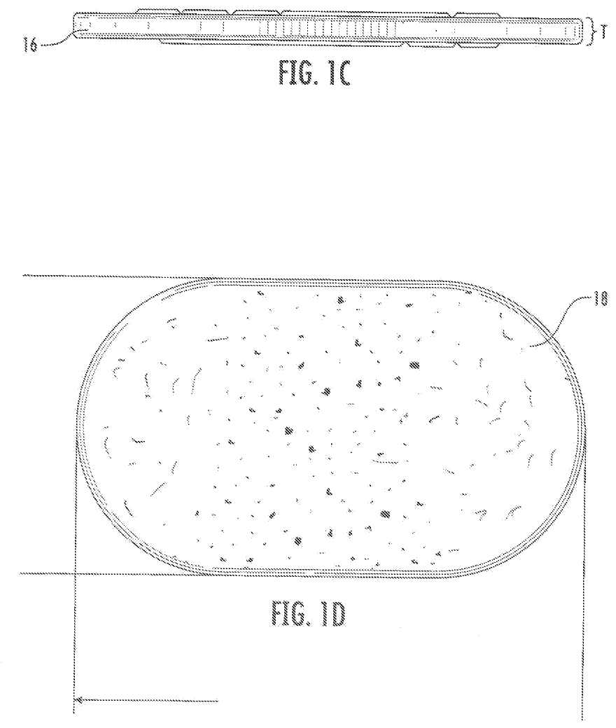

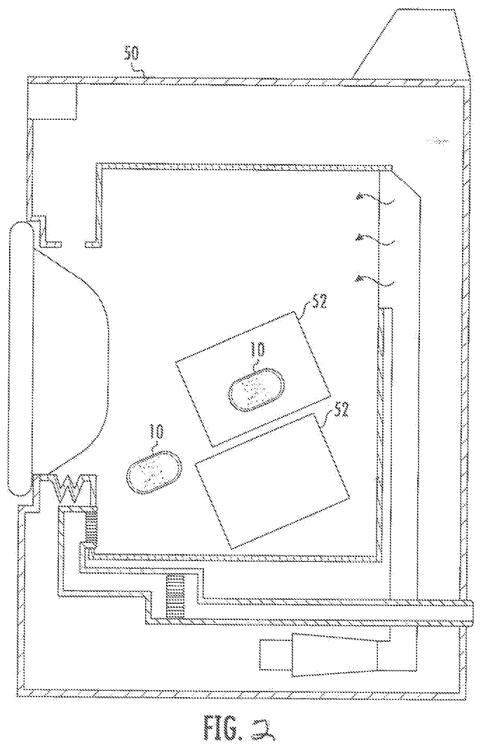

FIGS. 1A-1D illustrate dryer additive delivery device 10 in accordance with the teachings of the present invention. Dryer additive delivery device 10 includes body 11. Dryer additive delivery device 10 can be formed of a plastic or thermoplastic material 12 formed from the polymerization of polyurethane or olefins. Suitable polyolefins include polyethylene and polypropylene.

Thermoplastic material 12 can comprise a polymer. Suitable thermoplastic materials 12 include: polypropylene (PP); nylon; polycarbonate (PC); polystyrene (PS); styrene acrylonitrile (SAN); acrylonitrile butadiene styrene (ABS); high density polyethylene (HDPE); low density polyethylene (LDPE); acetal; polyacetal; polyoxymethylene (POM); polysulfone (PSU); polybutylene terephthalate (PBT); polyethylene terephthalate (PET); ester-based thermoplastic polyurethane elastomer (TPUR); ether-based thermoplastic polyurethane elastomer (TPUR); polyphenylene sulfide (PPS); polyethersulfone (PES); polyether-ester block copolymer thermoplastic Elastomer (TEEE; modified polyphenylene oxide (PPO); acrylic; poly(methyl methacrylate) (PMMA); polycarbonate/acrylic alloy (PC/PMMA); polyetherimide (PEI); Polyolefin; polycarbonate/polyester (PC/PBT); polyetheretherketone (PEEK); polyetherketone (PEK); rigid thermoplastic polyurethane (RTPU); polycarbonate/ABS alloy (PC/ABS); styrenic block copolymer thermoplastic elastomer (SBC); thermoplastic vulcanizate (TPV); polymethylpentene (PMP); polyvinylidene fluoride (PVDF); fluorinated ethylene propylene (FEP); polyetherketoneetherketoneketone (PEKEKK); polyphthalamide (PPA); polyetherketoneketone (PEKK); thermoplastic polyimide (TPI); polysulfone/polycarbonate alloy (PSU/PC), high temperature nylon (HTN); polyketone (PK); syndiotactic polystyrene (SPS); thermoplastic polyolefin (TPO) and thermoplastic elastomer (TPE). Preferably, thermoplastic material 12 is a high density polyethylene (HDPE).

Thermoplastic material 12 can include a wax. The wax can be hydrogenated tallow fatty acid (HTFA).

Fragrance additive 13 can be included in body 11. Fragrance additive 13 can be infused in thermoplastic material 12. In one embodiment, fragrance additive 13 is infused or trapped ethyl vinyl acetate (EVA). The ethyl vinyl acetate (EVA) can be combined or blended in thermoplastic material 12, such as a high density polyethylene (HDPE). In one embodiment, fragrance additive 13 can be added to a polyolefin used for injection molding of dryer additive delivery device 10.

Fragrance additive 13 can be added to the plastic or thermoplastic material 12 when forming dryer additive delivery device 10. The fragrance additive can comprise a fragrance and a solvent. Example fragrances include citrus, fruity, floral, powdery, aromatic, oriental, green and woody. A fragrance additive can be a fragrance oil for polymer. Example fragrance oil for polymers are manufactured by Agilex Fragrance, Piscataway NJ. The fragrance additive can be used in an amount of about 20% to about 60% by weight of the composition of the plastic or thermoplastic material. Preferably, the fragrance additive is used in an amount of about 20% to about 40% by weight of the composition of the plastic or thermoplastic material 12. Example fragrances include citrus, floral, powdery, aromatic, fruity, oriental, green and woody. A fragrance additive can be a fragrance oil for polymer. Example fragrance oil for polymers are manufactured by Agilex Fragrance, Piscataway NJ.

Additives including materials used as an emulsifier, lubricant, dispersant, gelling agent, stabilizer, binder, and viscosity modifier can be combined with thermoplastic material 12. The additive materials can include fatty acids compounds extracted from a variety of vegetable, animal, and oil sources. A suitable additive is sodium stearate. A suitable emulsifier additive is stearic acid. Additives can include colorants.

Dryer additive delivery device 10 can be formed from a blended polymer compound with fragrance additive 13. Processing of the blended polymer compound results in fragrance additive 13 being infused or trapped in the polymer. In one embodiment, the additive is a fragrance oil which is blended into ethyl vinyl acetate (EVA). The blended polymer compound can be injection moulded into the shape of dryer additive delivery device 10.

Dryer additive delivery device 10 can have a streamline shape, as shown in FIGS. 1B-1D. Front 14 and rear 18 of dryer additive delivery device 10 can have a matching disc shape. Dryer additive delivery device 10 can have a disc, oval or circular shape. For example, dryer additive delivery device 10 can have a width W and length L in the range of about 1 to about 6 inches, or a range of about 2 to about 4 inches or a range of about 3 to about 4 inches. Side 16 of dryer additive delivery device 10 can have a thickness T of about ¼ to about ½ inch. Front 14, side 16 and rear 18 can be integral to one another.

A method for applying fragrance and removing static and wrinkles from one or more materials 52 comprises placing one or more dryer additive delivery devices 10 in clothes dryer 50 before or after loading the one or more materials 52 into clothes dryer 50 and tumbling the one or more dryer additive delivery devices 10 with one or more materials 22 during a drying cycle as shown in FIG. 2. After the drying cycle, the one or more dryer additive delivery devices 10 can be removed from clothes dryer 50 and re-used or discarded. The streamline shape of dryer additive delivery device 10 allows dryer additive delivery device 10 to slide freely throughout one or more materials 52 minimizing hang-ups and creating less friction between dryer additive delivery device 10 and one or more materials 52. Clothes dryer 50 can be a conventional clothes dryer. For example, material 52 can be fabric or clothing.

### Example 1

An example of a dryer additive delivery device can be formed of the following ingredients.

| | Sample | | |
|---|---|---|---|
| Material | Mix LBS | Mix Grams | Gram Each |
| Frag | 5.500 | 2494.250 | 2.4409 |
| EVA | 11.000 | 4988.500 | 4.8818 |
| HDPE | 5.100 | 2312.850 | 2.2634 |
| Color | 0.400 | 181.400 | 0.1775 |
| Tallow hydrogenated | 5.000 | 2267.500 | 2.2190 |
| Stearic acid | 0.360 | 163.260 | 0.1598 |
| Sodium Stearate | 0.130 | 58.955 | 0.0577 |
| Total | 27.490 | 12466.715 | 12.200 |

The ingredients were blended together. The dryer additive delivery device includes EVA, 18.552% HDPE, 18.188% hydrogenated tallow, 20.007% fragrance, 1.310% stearic acid, 0.473% sodium stearate and 1.455% color.

### Example 2

An example fragrance EVA infusion can include 33.333% fragrance and 66.667% EVA.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A dryer additive delivery device comprising:
a body, said body being formed of a first thermoplastic material,
the first thermoplastic material comprising a polymer including a fragrance additive,
wherein the shape of the body allows the dryer delivery device to slide freely throughout one or more materials placed in a clothes dryer.

2. The dryer additive delivery device of claim 1 wherein the first thermoplastic material includes a wax.

3. The dryer additive delivery device of claim 2 wherein the wax is hydrogenated tallow fatty acid.

4. The dryer additive delivery device of claim 1 wherein the first thermoplastic material comprises high density polyethylene (HDPE).

5. The dryer additive delivery device of claim 1 wherein the first thermoplastic material comprises ethyl vinyl acetate (EVA).

6. The dryer additive delivery device of claim 1 wherein the fragrance additive is infused in a second thermoplastic material, the second thermoplastic material is combined or blended with the first thermoplastic material.

7. The dryer additive delivery device of claim 6 wherein the first thermoplastic material is high density polyethylene (HDPE) and the second thermoplastic material is ethyl vinyl acetate (EVA).

8. The dryer additive delivery device of claim 1 wherein the fragrance additive is about 20% to about 60% by weight of the composition of the thermoplastic material.

9. The dryer additive delivery device of claim 1 wherein the fragrance additive comprises a fragrance and a solvent.

10. The dryer additive delivery device of claim 1 wherein the fragrance additive comprises a fragrance selected from one or more of citrus, fruity, floral, powdery, aromatic, oriental, green and woody.

11. The dry dryer additive delivery device of claim 1 wherein the first thermoplastic material is one or more materials selected from the group consisting of polypropylene (PP); nylon; polycarbonate (PC); polystyrene (PS); styrene acrylonitrile (SAN); acrylonitrile butadiene styrene (ABS); high density polyethylene (HDPE); low density polyethylene (LDPE); acetal; polyacetal; polyoxymethylene (POM); polysulfone (PSU); polybutylene terephthalate (PBT); polyethylene terephthalate (PET); ester-based thermoplastic polyurethane elastomer (TPUR); ether-based thermoplastic polyurethane elastomer (TPUR); polyphenylene sulfide (PPS); polyethersulfone (PES); polyether-ester block copolymer thermoplastic Elastomer (TEEE; modified polyphenylene oxide (PPO); acrylic; poly(methyl methacrylate) (PMMA); polycarbonate/acrylic alloy (PC/PMMA); polyetherimide (PEI); polyolefin; polycarbonate/polyester (PC/PBT); polyetheretherketone (PEEK); polyetherketone (PEK); rigid thermoplastic polyurethane (RTPU); polycarbonate/ABS alloy (PC/ABS); styrenic block copolymer thermoplastic elastomer (SBC); thermoplastic vulcanizate (TPV); polymethylpentene (PMP); polyvinylidene fluoride (PVDF); fluorinated ethylene propylene (FEP); polyetherketoneetherketoneketone (PEKEKK); polyphthalamide (PPA); polyetherketoneketone (PEKK); thermoplastic polyimide (TPI); polysulfone/polycarbonate alloy (PSU/PC), high temperature nylon (HTN); polyketone (PK); syndiotactic polystyrene (SPS); thermoplastic polyolefin (TPO) and thermoplastic elastomer (TPE).

12. The dryer additive delivery device of claim 1 wherein the fragrance additive is released over time from the dryer additive delivery device.

13. The dryer additive delivery device of claim 1 wherein the body has a disc, oval or circular shape.

14. A method for forming a dryer additive delivery device comprising the steps of:
blending a polymer with a fragrance additive to form a blended polymer compound, and
injection molding the blended polymer compound into a shape of the dryer delivery device.

15. The method of claim 14 wherein the blended polymer compound comprises one or more of polyurethane, polyethylene, polypropylene and ethylene-vinyl acetate and the fragrance additive comprises a fragrance and a solvent.

16. A method for applying a fragrance to one or more materials comprising the steps of:
placing one or more dryer additive delivery devices in a clothes dryer before or after loading of the one or more materials into the clothes dryer, and
tumbling the one or more dryer additive delivery devices with the one or more materials in the clothes dryer,
wherein the dryer additive delivery device comprises a body, said body being formed of a first thermoplastic material, the first thermoplastic material comprising a polymer including a fragrance additive, the shape of the body allows the dryer delivery device to slide freely throughout one or more materials placed in a clothes dryer.

17. The method of claim 16 wherein the one or more materials are fabrics or clothing.

18. The method of claim 16 wherein the first thermoplastic material includes a wax.

19. The method of claim 16 wherein the fragrance additive is infused in a second thermoplastic material, the second thermoplastic material is combined or blended with the first thermoplastic material.

20. The method of claim 16 wherein the first thermoplastic material is one or more materials selected from the group consisting of polypropylene (PP); nylon; polycarbonate (PC); polystyrene (PS); styrene acrylonitrile (SAN); acrylonitrile butadiene styrene (ABS); high density polyethylene (HDPE); low density polyethylene (LDPE); acetal; polyacetal; polyoxymethylene (POM); polysulfone (PSU); polybutylene terephthalate (PBT); polyethylene terephthalate (PET); ester-based thermoplastic polyurethane elastomer (TPUR); ether-based thermoplastic polyurethane elastomer (TPUR); polyphenylene sulfide (PPS); polyethersulfone (PES); polyether-ester block copolymer thermoplastic Elastomer (TEEE; modified polyphenylene oxide (PPO); acrylic; poly(methyl methacrylate) (PMMA); polycarbonate/acrylic alloy (PC/PMMA); polyetherimide (PEI); polyolefin; polycarbonate/polyester (PC/PBT); polyetheretherketone (PEEK); polyetherketone (PEK); rigid thermoplastic polyurethane (RTPU); polycarbonate/ABS alloy (PC/ABS); styrenic block copolymer thermoplastic elastomer (SBC); thermoplastic vulcanizate (TPV); polymethylpentene (PMP); polyvinylidene fluoride (PVDF); fluorinated ethylene propylene (FEP); polyetherketoneetherketoneketone (PEKEKK); polyphthalamide (PPA); polyetherketoneketone (PEKK); thermoplastic polyimide (TPI); polysulfone/polycarbonate alloy (PSU/PC), high temperature nylon (HTN); polyketone (PK); syndiotactic polystyrene (SPS); thermoplastic polyolefin (TPO) and thermoplastic elastomer (TPE).
